(19) United States
(12) Patent Application Publication
(10) Pub. No.: US 2023/0237470 A1
(43) Pub. Date: Jul. 27, 2023

(54) DIGITAL CARD INTEGRATION WITH CARD PROCESSING SYSTEM OF CARD ISSUER

(71) Applicant: Entrust Corporation, Shakopee, MN (US)

(72) Inventors: NICOLAS BRULEY, Paris (FR); DAVID COMBALUZIER, Malakoff (FR)

(73) Assignee: Entrust Corporation, Shakopee, MN (US)

(21) Appl. No.: 18/102,526

(22) Filed: Jan. 27, 2023

Related U.S. Application Data
(60) Provisional application No. 63/303,780, filed on Jan. 27, 2022.

(51) Int. Cl. G06Q 20/36; G06Q 20/34; G06F 8/30

(52) U.S. Cl. CPC G06Q 20/3674; G06Q 20/351; G06F 8/30

(57) ABSTRACT

Methods and systems for managing a digital wallet are described, including registration of payment cards and use of such payment cards. The digital wallet may be integrated into a mobile application provided by a card issuer, with the digital wallet providing integration between the mobile application and a payment service provider that provides token-based payment systems for implementing virtual cards.

### CROSS-REFERENCE TO RELATED APPLICATIONS

The present application claims priority from U.S. Provisional Patent Application No. 63/303,780, filed on Jan. 27, 2022, the disclosure of which is hereby incorporated by reference in its entirety.

### BACKGROUND

Digital cards have been made possible by tokenization systems introduced by card networks. Examples include Mastercard MDES, Visa VTS, and Cartes Bancaires CB Digital Hub. These tokenization systems have allowed banks to digitize their card portfolio, replacing sensitive card numbers with tokens dedicated to specific use cases for enhanced security. Concurrently, consumers and card issuers are increasingly moving away from physical cards towards entirely digital cards.

This migration toward digital card systems has led to significant challenges. For example, financial institutions are faced with integration with multiple tokenization systems, since the different card issuers, local governments, and standards bodies often have adopted different tokenization schemes. In order to implement such innovations, issuers often rely on several card systems, leading to significant complexity, multiple back end card issuer integrations, and long development timelines.

Furthermore, digital cards often require close integration with mobile banking applications. Because card enrollment, payment, balance check, card management, and authentication processes typically are all available within a mobile banking application, banking institutions have a need to offer digital cards that integrate with such applications to provide a unified service to customers.

When a digital card is provided to a customer, including within a mobile banking application, certain functions are typically made available to the customer, including display of card number information and PIN information (collectively, “card information”). However, because this card information is sensitive, there is a need for a technological solution that provides significant security (e.g., being PCI-DSS compliant), which limits the flexibility of many existing systems.

### SUMMARY

In general terms, the present application is directed to methods and systems for managing a digital wallet, including registration of payment cards and use of such payment cards. The digital wallet may be integrated into a mobile application provided by a card issuer, with the digital wallet providing integration between the mobile application and a payment service provider that provides token-based payment systems for implementing virtual cards.

In a first aspect, a method of integrating a digital payment card with a card issuer mobile application is provided. The method includes receiving, from a mobile application at a card issuer, a card identifier that identifies a payment card, and sending, from the card issuer to a wallet server, card identification information including the card identifier and an identifier of a cardholder associated with the payment card. The method further includes receiving, from the wallet server, card push data at the card issuer; and providing card push data to the mobile application. The mobile application provides, via a software development kit (SDK) associated with the wallet server, card enrollment push data to the wallet server.

In a second aspect, a method of integrating a digital payment card with a card issuer mobile application is provided. The method includes receiving, at a wallet server from a card issuer, card identification information including a card identifier that identifies a payment card and an identifier of a cardholder associated with the payment card. The method also includes sending, from the wallet server, card push data to the card issuer. The method further includes receiving first information representative of funding card push data from a mobile device having a mobile application installed thereon, the mobile application interfacing with the wallet server via a software package installed on the mobile device and configured to directly communicate with the wallet server, the funding card push data including an identifier associated with the mobile device.

In a third aspect, a method includes receiving a request for a token-based payment feature at a wallet server, the request being received directly from a software development kit (SDK) installed at a mobile device and integrated with a mobile application associated with a card issuer, the SDK being provided by an entity controlling the wallet server. The method includes submitting card and transaction information from the wallet server to a token service provider for use of the token-based payment feature, and receiving, at the wallet server, a response from the token service provider indicating a result of the submission of the card and transaction information. The method further includes forwarding the result to the mobile device via the SDK, the result being provided to the mobile application provided by the card issuer.

### BRIEF DESCRIPTION OF THE DRAWINGS

FIG. 1 illustrates an example environment in which aspects of the present disclosure may be implemented.

FIG. 2A illustrates an example method of registration of card data in a mobile wallet from the perspective of a card issuer linked to a wallet server, in accordance with aspects of the present disclosure.

FIG. 2B illustrates an example method of registration of card data in a mobile wallet from the perspective of a wallet server, in accordance with aspects of the present disclosure.

FIG. 3 illustrates an example method of using a registered funding card within a digital wallet that is registered in accordance with the methods described above in conjunction with FIGS. 2A-2B.

FIG. 4 illustrates an example message flow among a mobile device, a card issuer, and a wallet server for enrolling a card within a digital wallet, according to an example embodiment.

FIG. 5 illustrates an example message flow among a mobile device, a card issuer, a wallet server, and a token service provider for conducting a payment transaction using a card within a digital wallet.

FIG. 6 illustrates an example computing device with which aspects of the present disclosure can be implemented.

### DETAILED DESCRIPTION

As briefly described above, embodiments of the present invention are directed to methods and systems for managing a digital wallet, including registration of payment cards and use of such payment cards. The digital wallet may be integrated into a mobile application provided by a card issuer, with the digital wallet providing integration between the mobile application and a payment service provider that provides token-based payment systems for implementing virtual cards.

Generally speaking, the digital wallet as described herein provides a convenient method of integrating mobile applications provided by card issuers (e.g., banks or other financial institutions) with token service providers, such as Mastercard MDES, Visa VTS, and Cartes Bancaires CB Digital Hub or other similar providers who utilize token-based transactions. The digital wallet may maintain sufficient data to represent a virtual card, and may do so in either a centralized location at a wallet server, or distributed across a wallet server and a secure, mobile software development kit (SDK) that can be integrated with a mobile application provided by the card issuer. Accordingly, card issuers do not need to develop their own interfaces to token service providers, and may rely on a digital wallet, and wallet server, for providing an interface to any of a variety of token service providers. Therefore, from the perspective of the card issuer, integration with additional token service providers is straightforward, since it is managed by the wallet server on behalf of the card issuer.

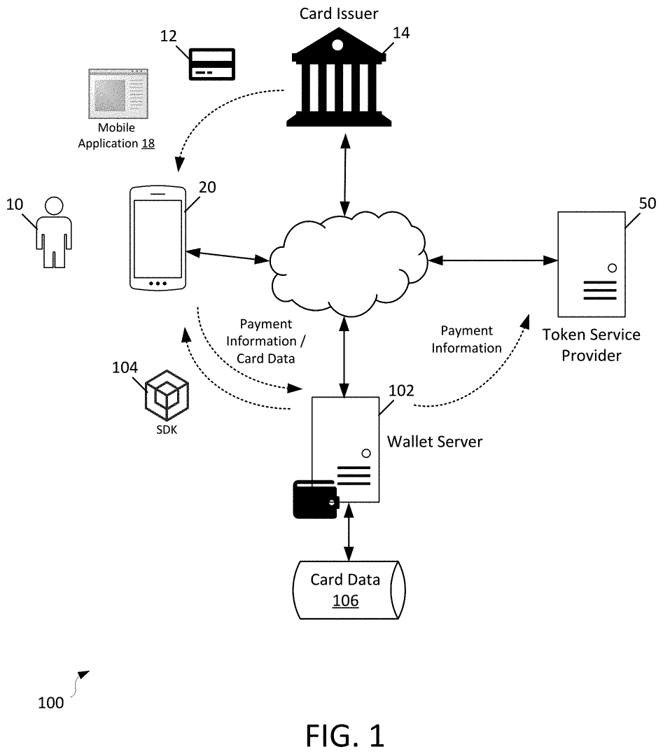

Referring now to FIG. 1, an example environment 100 in which aspects of the present disclosure may be implemented is shown. In the example environment 100, a user 10 may be issued a payment card, such as a credit card 12, by a card issuer 14. The credit card 12 may be a physical credit card, or may be solely a virtual card. The card issuer 14 may be a bank or other financial institution, and the user 10 may have one or more accounts with the card issuer, including a credit account, or other types of banking accounts (e.g. checking and/or savings accounts).

To allow user 10 to manage his or her accounts, the card issuer 14 may provide to the user 10 a mobile application 18 installable on a mobile device 20. The mobile application 18 may be configured to receive user credentials and allow access to account information of the user 10 at the financial institution represented by the card issuer 14.

In example implementations, the user 10 may wish to store a digital version of credit card 12 in a mobile wallet on his or her mobile device 20. The mobile wallet may be implemented within the mobile application 18. In traditional implementations, the mobile application 18 may be required to integrate with a token service provider 50, for example to exchange tokens representing payment details including card information. However, in such configurations, the mobile application 18 would be required to define the interface to the token service provider 50.

In the example shown, a wallet server 102 may be in communication with each of the card issuer 14, mobile device 20, and token service provider 50. As described further below, the wallet server 102 may be coupled with a mobile software development kit (SDK) 104 to provide an interface between the mobile application 18 and token service provider 50, and to maintain payment card details of, e.g., a credit card 12 issued by the card issuer 14.

In example implementations, the mobile SDK 104 may be provided to the mobile device 20 for integration with mobile application 18 directly from the wallet server 102. In other implementations, the mobile SDK 104 may be provided to the card issuer for integration with mobile application 18, which in turn may be accessed and installed on a mobile device 20 by user 10. Accordingly, at the time of installation, the mobile device 20 will have both the mobile application 18 and mobile SDK 104, and will be configured for communication with both the card issuer 14 and with wallet server 102 such that, at the time user 10 wishes to register a payment card within a mobile wallet on the mobile device 20, such a mobile wallet (as implemented via the mobile SDK 104 and wallet server 102) is in place and ready for use.

In example implementations, payment card information may be provided from the mobile device 20 to the wallet server 102. The wallet server may provide payment information to a token service provider 50 once the wallet server 102 has the payment information and card data, and may act on behalf of the user and mobile application 18. As described in further detail below, card data may be stored in a car database 106 at the wallet server 102, may be maintained in storage at the mobile device 20 via the SDK 104, or a combination thereof. In examples, a cipher of the card information may be stored at each of the mobile device 20 and wallet server 102, for reconstruction prior to submission of a payment request to the token service provider 50. Accordingly, card information may only be maintained on either the mobile device 20 or the public server 102 at the time of the transaction, rather than retaining card information at either location that may otherwise be compromised by access vulnerabilities or the like.

It is noted that, in the context of the environment 100 described in FIG. 1, the use of wallet server 102 and SDK 104 allows for a tight coupling between the mobile device 20 and the wallet server 102. In particular, for initial registration of a virtual card within a digital wallet, the mobile device may use the SDK 104 to communicate directly with the wallet server 102, rather than requiring intermediate communication with a mobile application server that may be hosted or managed by the card issuer 14. This reduces the amount of inter-entity communication that is required, thereby further improving efficiency and enhancing security.

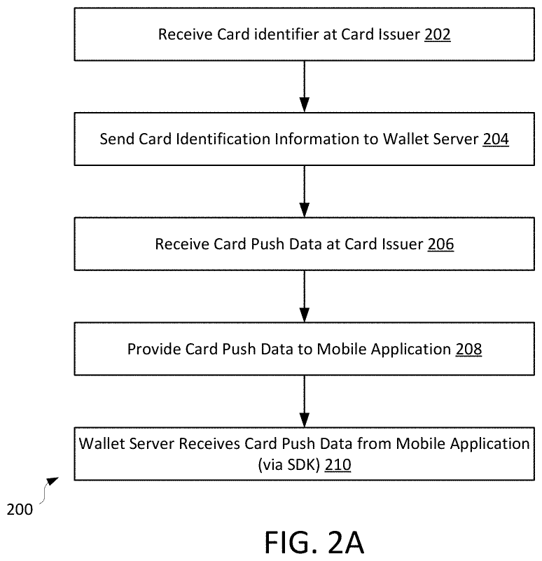

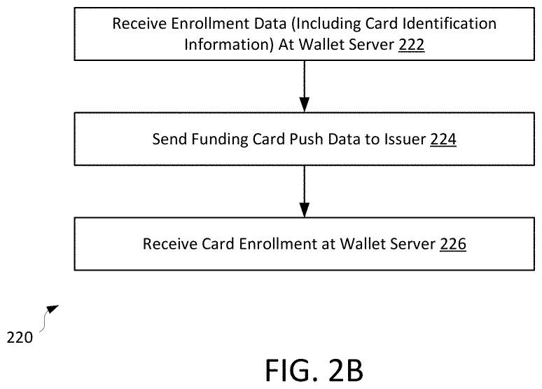

Referring now to FIG. 2A, an example method 200 of registration of card data in a mobile wallet is shown, in accordance with aspects of the present disclosure. The method 200 is described as incorporating operations performed from the perspective of a card issuer linked to a wallet server, as described above in conjunction with FIG. 1.

In the example shown, the method 200 includes receiving a card identifier at a card issuer, such as card issuer 14 (step 202). The card identifier may be received, for example, from a mobile application of a user such as user 10, and may identify a payment card to be added to a digital wallet. The card identifier may include card details, such as a card number, expiration date, and validation code.

As illustrated, the method 200 further includes sending enrollment data to a wallet server 102 from the card issuer 14 (step 204). The enrollment data may include, for example, the card identifier received from the mobile application, as well as an identifier of either the user or the digital wallet to which the card should be added. In an alternative, rather than sending only the card identifier alongside the identifier of the user or digital wallet, card data may instead be sent to the wallet server 102 from the issuer 14. The card data may include a primary account number (PAN) and an expiration date, and optionally a cryptogram used for securing such data.

In the example shown, the method 200 further includes receiving funding card push data from the wallet server 102 at the card issuer 14 (step 206). In turn, the card issuer will provide the push data to the mobile application (step 208). In response to providing the push data to the mobile application 18, the mobile device may be configured to provide to the push data from the mobile application to the wallet server 102, for example via the SDK 104 (step 210).

FIG. 2B illustrates an example method 220 of registration of card data in a mobile wallet from the perspective of a wallet server, in accordance with aspects of the present disclosure. In other words, method 220 is analogous to method 200, but from the perspective of wallet server 102, rather than from the perspective of card issuer 14.

In the example shown, the method 220 includes receiving enrollment data at the wallet server 102 (step 222). As described above in step 204 of method 200, the enrollment data will include a user identifier or a wallet identifier, alongside some card identifying information. The card identifying information may include a card identifier, or may be a primary account number and expiration date, alongside an optional cryptogram used for securing that data.

In the example shown, the method 220 further includes sending funding card push data to the card issuer 14 (step 224). The method further includes receiving card enrollment information from a mobile device at the wallet server 102 (step 226). In examples, the funding card push data format may be dependent, at least in part, on the token service provider for the given payment card. The funding card push data may include, for example, various payloads and cryptograms required for incorporation of the payment card into the digital wallet.

Although the exact construction of the funding card push data may vary between different token service providers, it is noted that the wallet server 102 maintains a definition of, and is capable of forming funding card push data on behalf of the card issuer, such that the wallet server 102 may forward the push data to the card issuer, which can in turn provide that push data to the mobile application 18 at the mobile device 20. The mobile application 18 may then complete enrollment by sending a message confirming enrollment to the wallet server 102, for example via the SDK 104 (at step 226). In this way, the wall a server 102 receives confirmation that the funding card push data provided to the card issuer is successfully provided to the mobile application, and confirms association between the card issuer 14, mobile device 20 of the user 10, and the specific user or wallet registered at the wallet server 102.

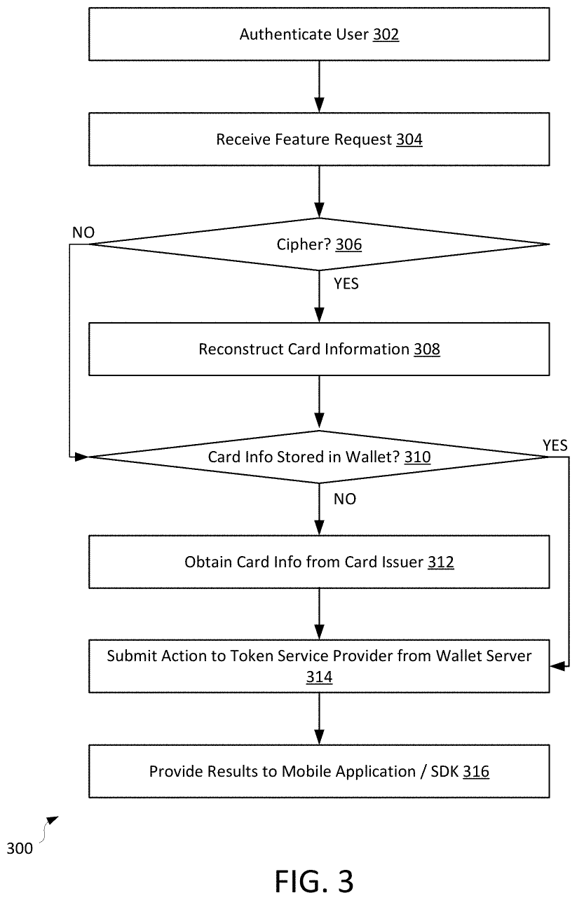

Referring now to FIG. 3, an example method 300 of using a registered funding card within a digital wallet that is registered in accordance with the methods described above in conjunction with FIGS. 2A-2B is shown. The method 300 may be performed, for example, using a mobile application having an SDK installed therewith, in association with a wallet server usable to interface with a token service provider, such as described above.

In the example shown, the method 300 includes authenticating a user, for example by receiving some type of user authentication information and validating that information against stored credentials (step 302). Authenticating the user can include, for example, receiving and comparing a pin code, receiving a fingerprint and comparing against a stored, known fingerprint, or any other type of known authentication process. In example implementations, the method 300 uses existing mobile device authentication processes to authenticate the user within a mobile application 18.

The method 300 further includes receiving a feature request (step 304). In examples, the feature request may be a request to make a payment using a token service provider. However, other types of requests may be utilized as well. For example, a request card details of a payment card that is associated with a token service provider, or to otherwise initiate a transaction using a token service provider. In examples, the feature request is received at the mobile device 20, for example via user input or via wireless communication with the mobile device e.g., via near field communication (NFC). The feature request may then be forwarded to the wallet server for processing in accordance with the particular token service provider that is associated with the payment card as previously registered within the user's digital wallet.

Once the wallet server has received the feature request, the wallet server 102 may then determine whether it has stored the relevant card data required to initiate a transaction with the token service provider 50 (step 306). For example, the wallet server 102 may store only a portion of the card information required to conduct the transaction, such as a cipher of the card information. In such a case, the wallet server may retrieve any other information required, for example by retrieving other deciphered information that may be used in combination with information stored at the wallet server to reconstruct card information (step 308). In example implementations, an exclusive or operation may be performed using a cipher on the card information, with the cipher stored at the SDK 104 on the user's mobile device 20, and the deciphered information stored in the card data 106 at the wallet server 102. The opposite storage configuration may be used as well.

If the wallet server 102 stores the entire card information, e.g. at the database 106, or after the card information is reconstructed, the wall a server may determine whether complete card information is stored in the user's wallet at the wallet server (step 310). Complete card information corresponds generally to information required to conduct a financial transaction. That is, the card information described above in steps 306-308 may be the card number, account number and expiration date, and other necessary information to conduct a financial transaction, or may alternatively simply be a card identifier. If the wallet server only stores a card identifier (e.g. for security purposes), the wallet server 102 may send a request to the card issuer 14 to obtain the card information required to conduct a financial transaction (step 312).

Once the wallet server 102 receives complete card information (e.g. either from card database 106, based on reconstruction from a cipher, or as obtained from card issuer 14, the wallet server 102 may submit an action to a token service provider 50 (step 314). The token service provider 50 may then return a result of the transaction (e.g. success or failure), and the wallet server 102 will provide a similar result to the mobile application 18 at the mobile device 20, e.g. via the SDK 104 (step 316). Accordingly, a user 10 of the mobile device 20 will receive immediate feedback regarding success or failure of the transaction to be performed via the token service provider 50.

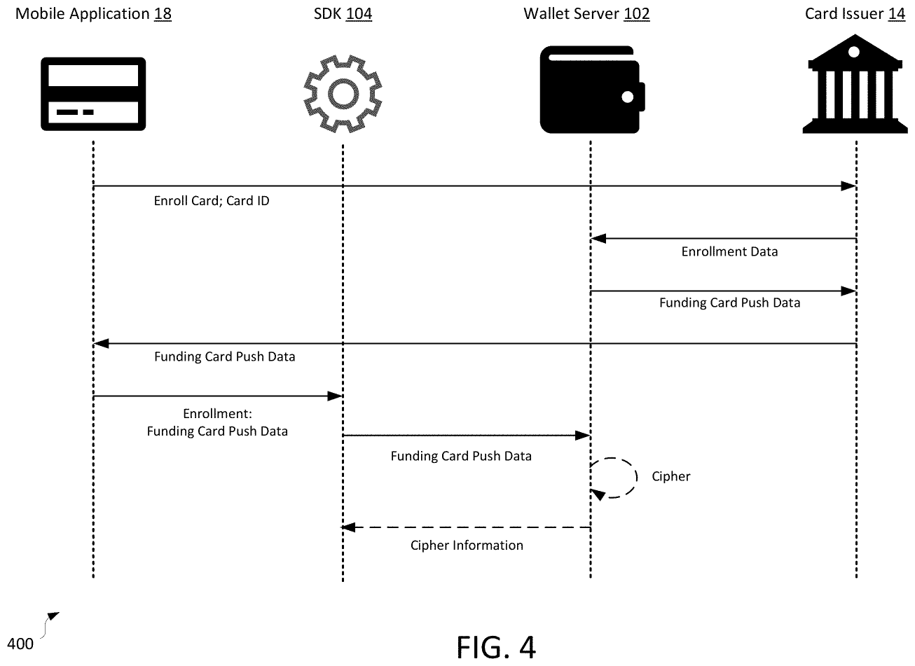

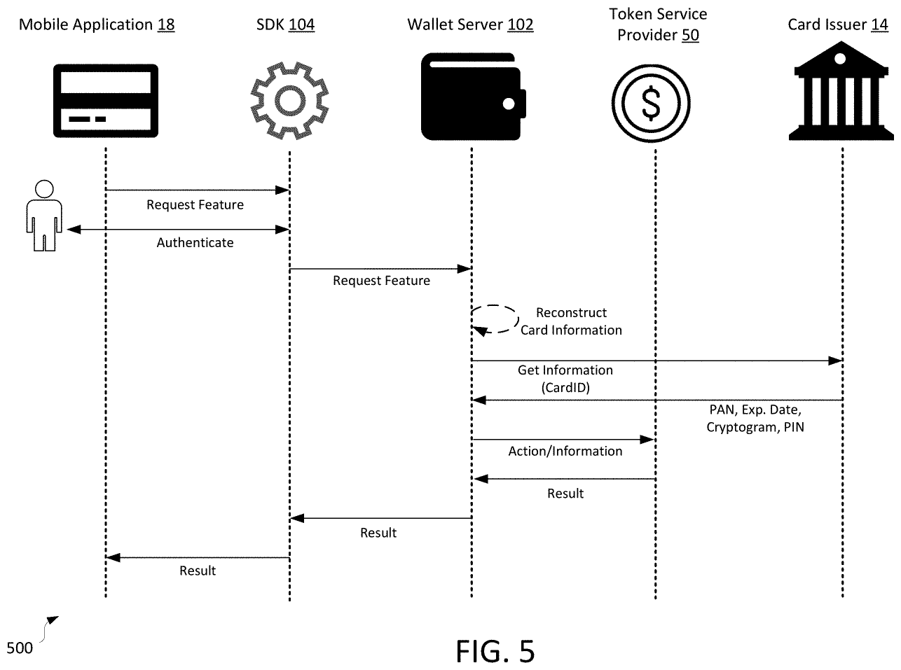

Referring now to FIGS. 4-5, a set of overall message flows are shown among a mobile device (e.g., a mobile device 20 having a mobile application 18 and SDK 104 installed thereon), a wallet server 102, a token service provider 50, and a card issuer 14 are shown. In particular, FIG. 4 illustrates a first example message flow 400 for enrolling a card within a digital wallet, and FIG. 5 illustrates an example message flow 500 for conducting a transaction using a card within a digital wallet.

Referring first to FIG. 4, the message flow 400 is initiated at a mobile application 20, which submits a request to enroll a card to a card issuer 14. The request to enroll the card can include a card identifier, for example a specific card identifier known to the card issuer, or new card information including a card number and expiration date, account number, or other types of card or account details. The card issuer 14, once the request is received and validated as coming from a known user, will send enrollment data to a wallet server 102. The wallet server will generate funding card push data, and send that funding card push data back to the card issuer 14.

In example embodiments, the enrollment data sent from the card issuer 14 to the wallet server 102 can include, for example, the card identification information, such as a card identifier or specific card details, as well as a wallet identifier or client identifier associated with the user, to ensure that the card details are stored in association with the appropriate user. The funding card push data can include, for example, specific funding card tokens or cryptograms required by a token service provider, and are generated at the wallet server 102 in accordance with the target token service provider to be used. Accordingly, the card issuer 14 does not need to know how to configure tokens for a particular token service provider, but instead may rely on the wallet server 102 to perform such functions.

Once the card issuer 14 receives the funding card push data, it may provide that funding card push data to the mobile application 18 at mobile device 20. The mobile application 18 may then confirm enrollment by sending the funding card push data to the SDK 104 which is associated with the wallet server 102. The SDK 104 may provide the funding card push data back to the wall server, thereby verifying that the card issuer 14 and mobile application 18 have successfully received that information. The wallet server 102 may then register the mobile application in association with the token service provider, and store that correlation in a digital wallet identified by the wallet identifier or user identifier.

In example embodiments, the wallet server 102 may not retain all enrollment data, i.e. all of the card identifying information. For example, it may be disadvantageous for the wallet server 102 to maintain card or payment account information, to avoid compromise of card information in the event of a data breach. Accordingly, in some embodiments, the wallet server may execute a cipher, such as an exclusive or operation on the card data. Cipher information, or the ciphered result, may be returned to the SDK 104 for storage on the mobile device 20. Thereafter, only a combination of the cipher and ciphered information may be used to re-create the card information, and therefore data at the wallet server alone (or at the mobile device 20 alone) is inadequate to disclose card information if data is compromised.

Referring to FIG. 5, a message flow 500 is illustrated that depicts usage of a token-based feature of a payment card via a token service provider 50, and using a digital wallet maintained by wallet server 102, in accordance with example embodiments. In the example shown, a user may request a feature of a payment card for example via a mobile application 18 on a mobile device 20. The mobile application 18 will submit the request to the SDK 104, which then requests authentication of the user 10. Authentication may be performed, for example, using a specific authentication method implemented by the SDK and wallet server 102 (e.g. using multifactor authentication, biometric authentication, or other means) or may rely on an authentication method provided locally at the mobile device by a mobile device operating system such as Apple FaceID, or a PIN code or fingerprint implemented either in AppleOS or Android mobile operating systems.

At the wallet server 102, card information is obtained for submission, ultimately, to a token service provider 50. In one embodiment, the wallet server 102 may store all relevant token information or payment card information required to communicate with the token service provider 50 to request the action (e.g. payment) to be performed. In such a case, the wallet server 102 may simply submit to the token service provider an action to be performed and receive a result in response. However, in other embodiments, the wallet server 102 may maintain only a portion of the card information. This may be because the wallet server 102 maintains only a cipher or ciphered version of the card information (referred to herein also as an example of “first information” useable to reconstruct card information), with a remainder (herein, an example of “second information”) being maintained at the SDK 104. It may also be because the wallet server 102 only retains a card identifier, with card details being maintained only by the card issuer 14.

If the wallet server 102 maintains only the cipher or ciphered version of the card information, the wallet server 102 may request remaining card information reconstruction data from the SDK 104, and reconstruct the card information before submitting a request for an action to the token service provider 50. If, for example, the wallet server maintains only a card identifier (or only reconstructs a card identifier from the cipher as described above), the wallet server may submit the card identifier to the card issuer prior to submitting a request to the token service provider 50. The card issuer 14 may return the primary account number, expiration date, and optionally a cryptogram and/or PIN used for securing transactions with the card information. Regardless of how the wallet server 102 receives the card information, ultimately it will submit the request for an action or information to the token service provider 50, receive a result, and pass that result back to the mobile application 18 via the SDK 104.

Notably, in FIGS. 4-5, communications with the token service provider 50 are mediated by the wallet server 102, in that the card issuer 14 and mobile device 20 do not need to communicate directly with the token service provider. Accordingly, to the extent different cards use different token service providers, or to the extent an API exposed by the token service provider may change over time, to integrate or change features offered by that provider, the wallet the server may be updated without requiring notification to either the mobile application 18 at the mobile device 20, or the card issuer 14. Still further, communications between the wallet server 102 and the card issuer 14 may be through an API exposed by the card issuer.

By using tight coupling between an SDK 104 and the wallet server 102, the present solution avoids a requirement of a mobile application having to relay data to a wallet server via a mobile application server or other computing system of the card issuer. Additionally, the wallet server 102 may directly communicate with both the mobile application 18 via the SDK 104, as well as with the card issuer 14 and token service provider 50, thereby improving overall communication efficiency within the payment network, which has an added benefit of increased security.

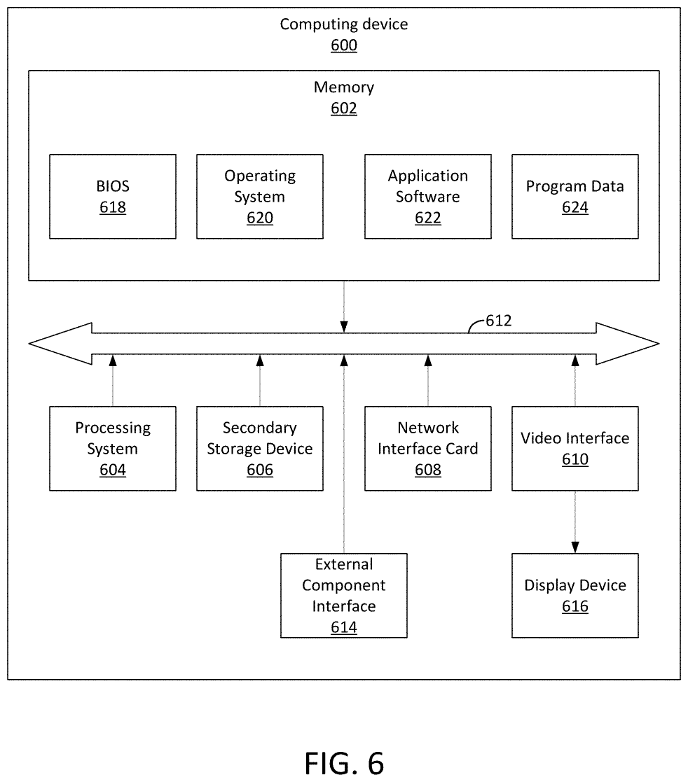

FIG. 6 illustrates an example computing device 600 with which aspects of the present disclosure can be implemented. The computing device 600 can be used, for example, as a single device or a networked group of devices to implement the mobile device 20, the wallet server 102, the token service provider 50, or the card issuer 14 as described above.

In the example of FIG. 6, the computing device 600 includes a memory 602, a processing system 604, a secondary storage device 606, a network interface card 608, a video interface 610, a display unit 612, an external component interface 614, and a communication medium 616. The memory 602 includes one or more computer storage media capable of storing data and/or instructions. In different embodiments, the memory 602 is implemented in different ways. For example, the memory 602 can be implemented using various types of computer storage media, and generally includes at least some tangible media. In some embodiments, the memory 602 is implemented using entirely non-transitory media.

The processing system 604 includes one or more processing units, or programmable circuits. A processing unit is a physical device or article of manufacture comprising one or more integrated circuits that selectively execute software instructions. In various embodiments, the processing system 604 is implemented in various ways. For example, the processing system 604 can be implemented as one or more physical or logical processing cores. In another example, the processing system 604 can include one or more separate microprocessors. In yet another example embodiment, the processing system 604 can include an application-specific integrated circuit (ASIC) that provides specific functionality. In yet another example, the processing system 604 provides specific functionality by using an ASIC and by executing computer-executable instructions.

The secondary storage device 606 includes one or more computer storage media. The secondary storage device 606 stores data and software instructions not directly accessible by the processing system 604. In other words, the processing system 604 performs an I/O operation to retrieve data and/or software instructions from the secondary storage device 606. In various embodiments, the secondary storage device 606 includes various types of computer storage media. For example, the secondary storage device 606 can include one or more magnetic disks, magnetic tape drives, optical discs, solid-state memory devices, and/or other types of tangible computer storage media.

The network interface card 608 enables the computing device 600 to send data to and receive data from a communication network. In different embodiments, the network interface card 608 is implemented in different ways. For example, the network interface card 608 can be implemented as an Ethernet interface, a token-ring network interface, a fiber optic network interface, a wireless network interface (e.g., WiFi, WiMax, etc.), or another type of network interface.

In optional embodiments where included in the computing device 600, the video interface 610 enables the computing device 600 to output video information to the display unit 612. The display unit 612 can be various types of devices for displaying video information, such as an LCD display panel, a plasma screen display panel, a touch-sensitive display panel, an LED screen, a cathode-ray tube display, or a projector. The video interface 610 can communicate with the display unit 612 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 614 enables the computing device 600 to communicate with external devices. For example, the external component interface 614 can be a USB interface, a FireWire interface, a serial port interface, a parallel port interface, a PS/2 interface, and/or another type of interface that enables the computing device 600 to communicate with external devices. In various embodiments, the external component interface 614 enables the computing device 600 to communicate with various external components, such as external storage devices, input devices, speakers, modems, media player docks, other computing devices, scanners, digital cameras, and fingerprint readers.

The communication medium 616 facilitates communication among the hardware components of the computing device 600. The communications medium 616 facilitates communication among the memory 602, the processing system 604, the secondary storage device 606, the network interface card 608, the video interface 610, and the external component interface 614. The communications medium 616 can be implemented in various ways. For example, the communications medium 616 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 602 stores various types of data and/or software instructions. The memory 602 stores a Basic Input/Output System (BIOS) 618 and an operating system 620. The BIOS 618 includes a set of computer-executable instructions that, when executed by the processing system 604, cause the computing device 600 to boot up. The operating system 620 includes a set of computer-executable instructions that, when executed by the processing system 604, cause the computing device 600 to provide an operating system that coordinates the activities and sharing of resources of the computing device 600. Furthermore, the memory 602 stores application software 622. The application software 622 includes computer-executable instructions, that when executed by the processing system 604, cause the computing device 600 to provide one or more applications. In the context of a mobile device, such as mobile device 20, the application software 622 may include one or more mobile applications installable thereon. The memory 602 also stores program data 624. The program data 624 is data used by programs that execute on the computing device 600.

Although particular features are discussed herein as included within an electronic computing device 600, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 600 of FIG. 6, the computer-readable instructions are stored on devices that include non-transitory media. In particular embodiments, the computer-readable instructions are stored on entirely non-transitory media

Referring to FIGS. 1-6 generally, it is noted that the configuration described above has a number of advantages regarding both convenience and security. Specifically regarding convenience, the above configuration allows card issuers to integrate with any of a variety of token service providers without significant additional effort as to mobile application development. Additionally, from the perspective of the user 10, integration with a particular token service provider is seamless, and the process for integrating with different token service providers is essentially the same. Regarding security, in example implementations the mobile application provided by the card issuer does not need to retain payment card details; such details are instead retained by the card issuer, and optionally by the wallet server. Still further, as an enhancement to security, even the wallet server may be configured to retain only a portion of payment card details by splitting, using a cryptographic cipher, payment card details across the mobile SDK 104 and the wallet server 102. Accordingly, neither the mobile SDK 104 nor the wallet server 102 retains full payment card details during times other than when a payment transaction is occurring, reducing the likelihood of compromise of payment card details.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A method of integrating a digital payment card with a card issuer mobile application, the method comprising:
receiving, from a mobile application at a card issuer, a card identifier that identifies a payment card;
sending, from the card issuer to a wallet server, card identification information including the card identifier and an identifier of a cardholder associated with the payment card;
receiving, from the wallet server, card push data at the card issuer; and
providing card push data to the mobile application;
wherein the mobile application provides, via a software development kit (SDK) associated with the wallet server, card enrollment push data to the wallet server.

2. The method of claim 1, wherein the card issuer comprises a financial institution.

3. The method of claim 1, wherein the identifier of the cardholder comprises at least one of a wallet identifier or a client identifier.

4. The method of claim 1, wherein the card identifier comprises at least one of a unique identifier of the payment card or a primary account number (PAN) and an expiry date of the payment card.

5. The method of claim 4, wherein the card identifier further includes a cryptogram associated with the payment card.

6. A method of integrating a digital payment card with a card issuer mobile application, the method comprising:
receiving, at a wallet server from a card issuer, card identification information including a card identifier that identifies a payment card and an identifier of a cardholder associated with the payment card;
sending, from the wallet server, card push data to the card issuer; and
receiving first information representative of funding card push data from a mobile device having a mobile application installed thereon, the mobile application interfacing with the wallet server via a software package installed on the mobile device and configured to directly communicate with the wallet server, the funding card push data including an identifier associated with the mobile device.

7. The method of claim 6, wherein the wallet server receives the funding card push data from the mobile device via the software package, and wherein the software package comprises a software development kit (SDK) installed on the mobile device, the SDK being provided by an entity controlling the wallet server for integration with the mobile application, wherein the mobile application is provided by the card issuer.

8. The method of claim 6, wherein the funding card push data includes at least one of a unique identifier of the payment card or a primary account number (PAN) and an expiry date of the payment card.

9. The method of claim 6, wherein the information representative of the funding card push data comprises the funding card push data.

10. The method of claim 6, wherein the information representative of the funding card push data includes a cipher of the funding card push data.

11. The method of claim 10, wherein the SDK retains second information representative of the funding card push data, and wherein reconstruction of the funding card push data at the SDK requires both the first information and the second information.

12. The method of claim 11, wherein the cipher comprises an exclusive-or operation executed on the funding card push data at the SDK to generate the first information and the second information.

13. The method of claim 6, further comprising:
receiving a request for a token-based payment feature at the wallet server, the request being received directly from the SDK;
submitting card and transaction information from the wallet server to a token service provider for use of the token-based payment feature;
receiving, at the wallet server, a response from the token service provider indicating a result of submitting the card and transaction information; and
forwarding the result to the mobile device via the SDK, the result being provided to the mobile application provided by the card issuer.

14. A method comprising:
receiving a request for a token-based payment feature at a wallet server, the request being received directly from a software development kit (SDK) installed at a mobile device and integrated with a mobile application associated with a card issuer, the SDK being provided by an entity controlling the wallet server;
submitting card and transaction information from the wallet server to a token service provider for use of the token-based payment feature;
receiving, at the wallet server, a response from the token service provider indicating a result of submitting the card and transaction information; and
forwarding the result to the mobile device via the SDK, the result being provided to the mobile application provided by the card issuer.

15. The method of claim 14, further comprising:
receiving, at the SDK, a user request for use of a token-based payment feature provided by a token service provider via the mobile application; and
receiving, at the SDK, user authentication information from a user of the mobile device,
wherein receiving the user request and the user authentication information occurs prior to receiving the request at the wallet server.

16. The method of claim 15, wherein the request for the token-based payment feature is generated by the SDK at least in part based on successful authentication of the user via the user authentication information.

17. The method of claim 14, further comprising, prior to receiving the request:
receiving, at the wallet server from the card issuer, card identification information including a card identifier that identifies a payment card and an identifier of a cardholder associated with the payment card;
sending, from the wallet server, card push data to the card issuer; and
receiving first information representative of funding card push data from the mobile device, the funding card push data including an identifier associated with the mobile device.

18. The method of claim 17, wherein the identifier of the cardholder comprises at least one of a wallet identifier or a client identifier.

19. The method of claim 17, wherein the information representative of the funding card push data includes a cipher of the funding card push data, and wherein the SDK retains second information representative of the funding card push data.

20. The method of claim 19, wherein reconstruction of the funding card push data at the SDK requires both the first information and the second information.

21. The method of claim 14, further comprising:
in response to the request, providing information representative of funding card push data from the wallet server to the SDK; and
receiving reconstructed funding card push data from the SDK at the wallet server and providing the funding card push data as part of the card and transaction information to the token service provider,
wherein reconstructed funding card push data is based on the information representative of the funding card push data stored at the wallet server and second information maintained at the SDK.
